(19) United States
(12) Patent Application Publication
(10) Pub. No.: US 2024/0351138 A1
(43) Pub. Date: Oct. 24, 2024

(54) LASER WELDING METHOD AND LASER WELDING DEVICE

(71) Applicant: Honda Motor Co., Ltd., Tokyo (JP)

(72) Inventors: Takashi KOBAYASHI, Tokyo (JP); Soichiro NAKASHIMA, Tokyo (JP)

(73) Assignee: Honda Motor Co., Ltd., Tokyo (JP)

(21) Appl. No.: 18/637,392

(22) Filed: Apr. 16, 2024

(30) Foreign Application Priority Data
Apr. 18, 2023 (CN) 202320862122.6

(51) Int. Cl. B23K 26/04; B23K 26/21; B23K 26/32; B23K 103/04

(52) U.S. Cl. CPC B23K 26/048; B23K 26/21; B23K 26/32; B23K 2103/04

(57) ABSTRACT

A laser welding method and a laser welding device is provided. The laser welding device is configured to weld workpieces stacking multiple using a laser. The laser welding device includes a first laser irradiator and a driving device configured to enable one of the first laser irradiator and the workpiece to move relative to the other one of the first laser irradiator and the workpiece. A laser irradiation angle of the first laser irradiator is configured to be located on a side opposite to a welding proceeding direction. Through adjusting a height of the first laser irradiator relative to the workpiece, the first laser irradiator irradiates the laser to the workpiece in a focused manner.

### CROSS-REFERENCE TO RELATED APPLICATION

This application claims the priority benefit of China application serial no. 202320862122.6, filed on Apr. 18, 2023. The entirety of the above-mentioned patent application is hereby incorporated by reference herein and made a part of this specification.

### BACKGROUND

### Technical Field

The disclosure relates to a welding method and a welding device, and in particular to a laser welding method and a laser welding device.

### Description of Related Art

Galvanized steel plate structure is generally formed by combining multiple stacked galvanized steel plates through a laser welding process. During the laser welding process of the galvanized steel plates, if a hole generated by a laser irradiating a workpiece (the galvanized steel plate) is too small, gasified metal ejected from the workpiece during laser welding may easily hit the workpiece and cause defects on the workpiece. Therefore, it is necessary to improve the laser welding device to overcome the above issues.

### SUMMARY

The disclosure provides a laser welding method and a laser welding device, which can prevent gasified metal ejected from a workpiece during laser welding from hitting the workpiece and causing defects on the workpiece.

The disclosure provides a laser welding method for welding a workpiece formed by stacking a plurality of plates using a laser. The laser welding method includes a welding step of moving the laser relative to the workpiece while irradiating the workpiece with the laser, wherein the laser is irradiated at an irradiation angle such that the laser is inclined toward a direction opposite to a welding proceeding direction, and the laser is irradiated such that a focal point of the laser is located in front of a hole generated by the laser irradiating the workpiece in the welding proceeding direction.

In the embodiment of the disclosure, a distance between a laser irradiator and the workpiece is adjusted such that the laser is irradiated in a focused manner.

In the embodiment of the disclosure, at least one of a moving speed of the laser and an output of the laser is controlled such that the focal point is located in front of the hole in the welding proceeding direction.

In the embodiment of the disclosure, for a melting depth of the laser, in a case that a length extending from the hole to a forward side in the welding proceeding direction while the laser is inclined with the irradiation angle is X and an opening size of the hole is D, the laser is irradiated such that a distance calculated by multiplying the moving speed of the laser by a time until the workpiece is gasified by irradiation by the laser is longer than D+X.

In the embodiment of the disclosure, a second laser is irradiated to a hole opening portion downstream from an irradiation position of the laser in the welding proceeding direction.

The disclosure provides a laser welding device for welding a workpiece formed by stacking a plurality of plates using a laser. The laser welding device includes a driving device configured to enable one of the laser and the workpiece to move relative to the other one of the laser and the workpiece, and a first laser irradiator configured at an irradiation angle such that the laser is inclined in a direction opposite to a welding proceeding direction. The laser is irradiated such that a focal point of the laser is located in front of a hole generated by the laser irradiating the workpiece in the welding proceeding direction.

In the embodiment of the disclosure, the first laser irradiator adjusts a height of the first laser irradiator relative to the workpiece such that the laser irradiates in a focused manner.

In the embodiment of the disclosure, the laser welding device further includes a control portion configured to control at least one of a moving speed of the laser and an output of the laser such that the focal point is located in front of the hole in the welding proceeding direction.

In the embodiment of the disclosure, for a melting depth of the laser, in a case that a length extending from the hole to a forward side in the welding proceeding direction while the laser is inclined with the irradiation angle is X and an opening size of the hole is D, the control portion irradiates the laser such that a distance calculated by multiplying the moving speed of the laser by a time until the workpiece is gasified by irradiation by the laser is longer than D+X.

In the embodiment of the disclosure, the laser welding device further comprising a second laser irradiator configured to irradiate a second laser to a hole opening portion downstream from an irradiation position of the laser by the first laser irradiator in the welding proceeding direction.

Based on the above, in the laser welding method and the laser welding device of the disclosure, the laser irradiation angle of the first laser irradiator is located on the side opposite to the welding proceeding direction, and the first laser irradiator irradiates the laser to the workpiece in the focused manner, so that the area of the hole generated on the workpiece by the first laser irradiator irradiating the laser to the workpiece is larger. Accordingly, gasified metal ejected from the workpiece during laser welding may easily pass through the hole and move away from the workpiece. Therefore, the laser welding method and the laser welding device of the disclosure can prevent gasified metal ejected from the workpiece during laser welding from hitting the workpiece and causing defects on the workpiece.

In order for the features and advantages of the disclosure to be more comprehensible, the following specific embodiments are described in detail in conjunction with the drawings.

### BRIEF DESCRIPTION OF THE DRAWINGS

FIG. 1 is a schematic diagram of a laser welding device according to an embodiment of the disclosure.

FIG. 2 shows a laser irradiating a workpiece of FIG. 1.

FIG. 3 is a schematic diagram of a laser welding device according to another embodiment of the disclosure.

FIG. 4 shows a laser irradiating a workpiece of FIG. 3.

### DESCRIPTION OF THE EMBODIMENTS

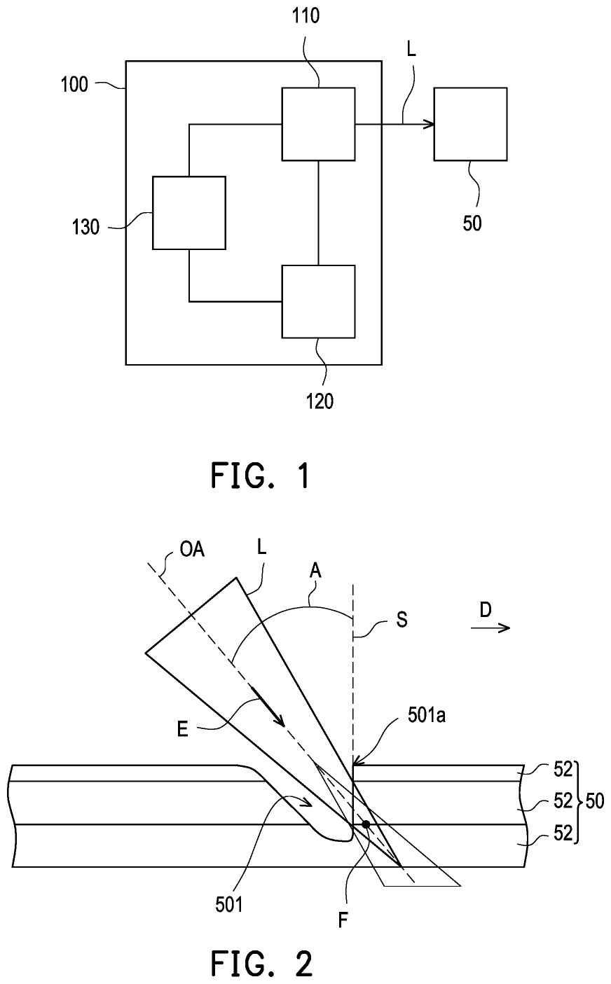

FIG. 1 is a schematic diagram of a laser welding device according to an embodiment of the disclosure. FIG. 2 shows a laser irradiating a workpiece of FIG. 1. Please refer to FIG. 1 and FIG. 2. A laser welding device 100 of the embodiment is configured to weld a workpiece 50 formed by stacking multiple galvanized steel plates 52 using a laser L. The laser welding device 100 includes a first laser irradiator 110 and a driving device 120. The driving device 120 enables one of the first laser irradiator 110 and the workpiece 50 to move relative to the other one of the first laser irradiator 110 and the workpiece 50. In the embodiment, the driving device 120 is, for example, connected to the first laser irradiator 110 and drives the first laser irradiator 110 to move relative to the workpiece 50 along a welding proceeding direction D.

In the embodiment, a laser irradiation angle A of the first laser irradiator 110 is configured to be located on a side opposite to the welding proceeding direction D. That is, an optical axis OA of the laser L is inclined toward the rear of the workpiece 50 in the welding proceeding direction D. Specifically, the first laser irradiator 110 irradiates the laser L to the workpiece 50 along an irradiation direction E to generate a hole 501 on the workpiece 50. The irradiation direction E is parallel to the optical axis OA of the laser L. A reference plane S is perpendicular to the welding proceeding direction D and intersects a front edge 501a of the hole 501 in the welding proceeding direction D. The optical axis OA of the laser L is inclined from the reference plane S at the laser irradiation angle A toward the rear of the reference plane S in the welding proceeding direction D.

Moreover, in the embodiment, through adjusting the height of the first laser irradiator 110 relative to the workpiece 50, the first laser irradiator 110 irradiates the laser L to the workpiece in a focused manner. Specifically, the laser welding device 100 of the embodiment further includes a control portion 130. The height of the first laser irradiator 110 relative to the workpiece 50 may be, for example, controlled by the control portion 130. The control portion 130 controls at least one of a moving speed of the driving device 120 and an output of the first laser irradiator 110, so that a focal point F of the laser L irradiated by the first laser irradiator 110 is located in front of the hole 501 in the welding proceeding direction D.

As mentioned above, in the laser welding method and the laser welding device 100 of the embodiment, the laser irradiation angle A of the first laser irradiator 110 is located on the side opposite to the welding proceeding direction D, and the first laser irradiator 110 irradiates the laser L to the workpiece 50 in the focused manner, so that an area of the hole 501 generated on the workpiece 50 by the first laser irradiator 110 irradiating the laser L to the workpiece 50 is larger. Accordingly, gasified metal ejected from the workpiece 50 during laser welding may easily pass through the hole 501 and move away from the workpiece 50. Therefore, the laser welding method and the laser welding device 100 of the embodiment can prevent gasified metal ejected from the workpiece 50 during laser welding from hitting the workpiece 50 and causing defects on the workpiece 50. In addition, an energy density of the laser L in a depth direction of the hole 501 can be increased to form a deeper hole 501, so as to increase the welding speed and weld a workpiece with a large thickness and/or a high melting point.

In the embodiment, the control portion 130 controls the moving speed of the driving device 120, so that the moving speed of the laser L is not too fast, so as to prevent an insufficient energy of the laser L irradiating the workpiece 50 due to the moving speed of the laser L being too fast and causing the formation of the hole 501 to be unstable, and prevent ejected gasified metal to move directly rearward in the hole 501 without being able to move upward to outside the hole 501 due to the moving speed of the laser L being too fast. Moreover, the control portion 130 controls the moving speed of the driving device 120, so that the moving speed of the laser L is not too slow, so as to prevent an excessive energy of the laser L irradiating the workpiece 50 due to the moving speed of the laser L being too slow and causing the formation of the hole 501 to be unstable, and prevent the area of the hole 501 from being too small due to the moving speed of the laser L being too slow and causing it to be difficult for ejected gasified metal to pass through the hole 501 and move away from the workpiece 50.

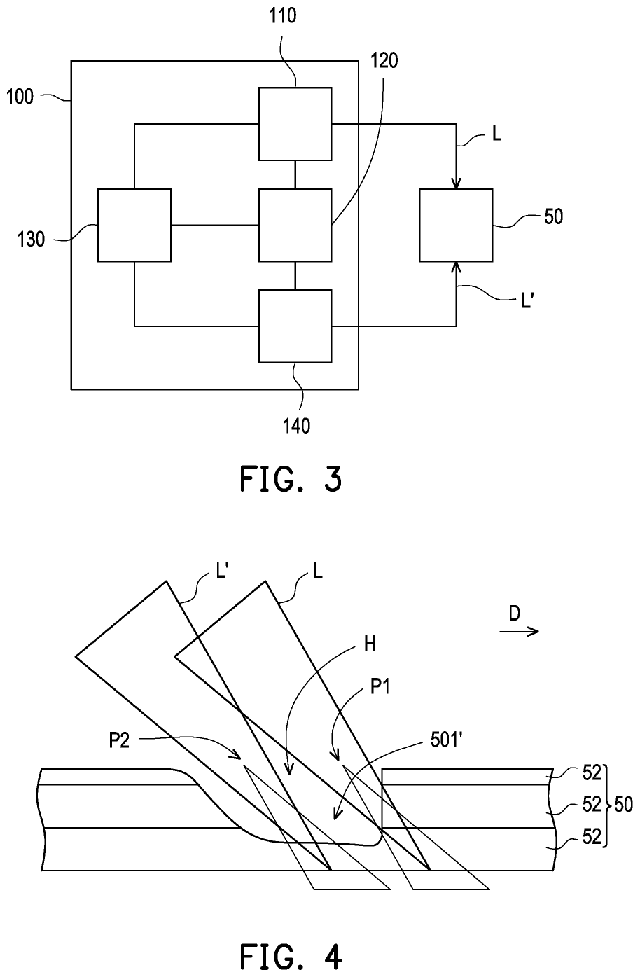

FIG. 3 is a schematic diagram of a laser welding device according to another embodiment of the disclosure. FIG. 4 shows a laser irradiating a workpiece of FIG. 3. The difference between the embodiment shown in FIG. 3 and FIG. 4 and the embodiment shown in FIG. 1 and FIG. 2 is that a laser welding device 100A shown in FIG. 3 and FIG. 4 further includes a second laser irradiator 140. The first laser irradiator 110 irradiates the laser L to the workpiece 50 at a first laser irradiation position P1, the second laser irradiator 140 irradiates a laser to an opening portion H of a hole 501′ at a second laser irradiation position P2, and the second laser irradiation position P2 is located downstream from the first laser irradiation position P1 in the welding proceeding direction D. Accordingly, the area of the hole 501′ and the energy density of the laser in a depth direction of the hole 501′ can be further increased.

In summary, in the laser welding method and the laser welding device of the disclosure, the laser irradiation angle of the first laser irradiator is located on the side opposite to the welding proceeding direction, and the first laser irradiator irradiates the laser to the workpiece in the focused manner, so that the area of the hole generated on the workpiece by the first laser irradiator irradiating the laser to the workpiece is larger. Accordingly, gasified metal ejected from the workpiece during laser welding may easily pass through the hole and move away from the workpiece. Therefore, the laser welding method and the laser welding device of the disclosure can prevent gasified metal ejected from the workpiece during laser welding from hitting the workpiece and causing defects on the workpiece.

Finally, it should be noted that the above embodiments are only used to illustrate, but not to limit, the technical solutions of the disclosure. Although the disclosure has been described in detail with reference to the above embodiments, persons skilled in the art should understand that the technical solutions described in the above embodiments may still be modified or some or all of the technical features thereof may be equivalently replaced. For example, in the embodiment, the galvanized steel plates are used as the workpiece 50 but not to limit. The material of the workpiece 50 is not limited as long as it is a metal that can be melted and joined by a laser welding device, and may be made of aluminum, copper, or the like. The modifications or replacements do not cause the essence of the corresponding technical solutions to deviate from the scope of the technical solutions of the embodiments of the disclosure.

What is claimed is:

1. A laser welding method for welding a workpiece formed by stacking a plurality of plates using a laser, comprising:
a welding step of moving the laser relative to the workpiece while irradiating the workpiece with the laser, wherein
the laser is irradiated at an irradiation angle such that the laser is inclined toward a direction opposite to a welding proceeding direction; and
the laser is irradiated such that a focal point of the laser is located in front of a hole generated by the laser irradiating the workpiece in the welding proceeding direction.

2. The laser welding method according to claim 1, wherein
a distance between a laser irradiator and the workpiece is adjusted such that the laser is irradiated in a focused manner.

3. The laser welding method according to claim 1, wherein
at least one of a moving speed of the laser and an output of the laser is controlled such that the focal point is located in front of the hole in the welding proceeding direction.

4. The laser welding method according to claim 3, wherein:
for a melting depth of the laser, in a case that a length extending from the hole to a forward side in the welding proceeding direction while the laser is inclined with the irradiation angle is X and an opening size of the hole is D,
the laser is irradiated such that a distance calculated by multiplying the moving speed of the laser by a time until the workpiece is gasified by irradiation by the laser is longer than D+X.

5. The laser welding method according to claim 1, wherein
a second laser is irradiated to a hole opening portion downstream from an irradiation position of the laser in the welding proceeding direction.

6. A laser welding device for welding a workpiece formed by stacking a plurality of plates using a laser, comprising
a driving device, configured to enable one of the laser and the workpiece to move relative to the other one of the laser and the workpiece; and
a first laser irradiator, configured at an irradiation angle such that the laser is inclined in a direction opposite to a welding proceeding direction, wherein
the laser is irradiated such that a focal point of the laser is located in front of a hole generated by the laser irradiating the workpiece in the welding proceeding direction.

7. The laser welding device according to claim 6, wherein:
the first laser irradiator adjusts a height of the first laser irradiator relative to the workpiece such that the laser irradiates in a focused manner.

8. The laser welding device according to claim 6, further comprising:
a control portion, configured to control at least one of a moving speed of the laser and an output of the laser such that the focal point is located in front of the hole in the welding proceeding direction.

9. The laser welding device according to claim 8, wherein:
for a melting depth of the laser, in a case that a length extending from the hole to a forward side in the welding proceeding direction while the laser is inclined with the irradiation angle is X and an opening size of the hole is D, the control portion irradiates the laser such that a distance calculated by multiplying the moving speed of the laser by a time until the workpiece is gasified by irradiation by the laser is longer than D+X.

10. The laser welding device according to claim 6, further comprising:
a second laser irradiator, configured to irradiate a second laser to a hole opening portion downstream from an irradiation position of the laser by the first laser irradiator in the welding proceeding direction.
